(19) United States
(12) Patent Application Publication
(10) Pub. No.: US 2018/0026939 A1
(43) Pub. Date: Jan. 25, 2018

(54) MONITORING DEVICE AND CARD REPLACING METHOD

(71) Applicant: FUJITSU LIMITED, Kawasaki-shi (JP)

(72) Inventor: Kazuaki NAGAMINE, Ota (JP)

(73) Assignee: FUJITSU LIMITED, Kawasaki-shi (JP)

(21) Appl. No.: 15/645,400

(22) Filed: Jul. 10, 2017

(30) Foreign Application Priority Data
Jul. 22, 2016 (JP) 2016-144856

(51) Int. Cl. H04L 29/12; H04L 12/24; H04L 12/26

(52) U.S. Cl. CPC H04L 61/2076; H04L 43/08; H04L 41/12

(57) ABSTRACT

A monitoring device is configured to couple to a transmission apparatus having a plurality of interface cards, and control a replacement of the plurality of interface cards, the monitoring device includes a memory in which state information including attribute information and an operating state are stored, a processor coupled to the memory and the processor configured to monitor the operating state of each of the plurality of interface cards associated with internal address information assigned to each of the plurality interface cards, determine whether first attribute information of a first interface card of the plurality of interface cards of a replacement source matches second attribute information of a second interface card of the plurality of interface cards of a replacement destination, and update external address information of the first interface card to external address information of the second interface card when the first attribute information matches the second attribute information.

### CROSS-REFERENCE TO RELATED APPLICATION

This application is based upon and claims the benefit of priority of the prior Japanese Patent Application No. 2016-144856, filed on Jul. 22, 2016, the entire contents of which are incorporated herein by reference.

### FIELD

The embodiments discussed herein are related to a monitoring device and a card replacing method.

### BACKGROUND

A shelf type transmission apparatus is mounted with a plurality of interface (IF) cards. In the shelf type transmission apparatus, there is an operation rule providing that, when an IF card is failed and the IF card of the failed replacement source is replaced with an IF card of a spare replacement destination, the IF card of the replacement destination is mounted in a slot in which the IF card of the replacement source has been mounted. Thus, since the server monitoring and controlling the transmission apparatus may specify the IF card of the replacement destination by conforming the slot positions of the replacement source and the replacement destination to each other, the server transfers setting information which is being set in the IF card of the replacement source, to the IF card of the replacement destination. As a result, the setting information of the IF card of the replacement source may be transferred to the IF card of the replacement destination.

Further, in recent years, rack mount type transmission apparatuses mounted with IF blades of which mounting positions are not decided have been distributed. A local IP address is assigned to each of the IF blades that are being mounted in the transmission apparatus, and the server monitoring and controlling the rack mount type transmission apparatus specifies each of the IF blades that are being mounted, with the local IP address. For example, when an IF blade in the transmission apparatus is failed and the failed IF blade of a replacement source is replaced with an IF blade of a replacement destination, the server may not specify a mounting position of the IF blade of the replacement destination. That is, since a local IP address is not assigned to the IF blade of the replacement destination, the server may not automatically specify the IF blade of the replacement destination. Thus, a local IP address is assigned to the IF blade of the replacement destination through a manual operation, and the server specify the IF blade of the replacement destination, and may transfer the setting information of the IF blade of the replacement source such as a global IP address to the IF blade of the replacement destination.

Related technologies are disclosed in, for example, Japanese Laid-Open Patent Publication Nos. 07-271695 and 07-058663.

### SUMMARY

According to an aspect of the invention, a monitoring device is configured to couple to a transmission apparatus having a plurality of interface cards, and control a replacement of the plurality of interface cards, the monitoring device includes a memory in which state information including attribute information and an operating state of each of the plurality of interface cards are stored, a processor coupled to the memory and the processor configured to monitor the operating state of each of the plurality of interface cards associated with internal address information assigned to each of the plurality interface cards, determine whether first attribute information of a first interface card of the plurality of interface cards of a replacement source matches second attribute information of a second interface card of the plurality of interface cards of a replacement destination, and update external address information of the first interface card to external address information of the second interface card when the first attribute information matches the second attribute information.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is an explanatory view illustrating an example of a transmission system 1 according to an embodiment;

FIG. 2 is an explanatory view illustrating an exemplary interior of an NE 2;

FIG. 3 is an explanatory view illustrating an exemplary DB configuration of a state management DB;

FIG. 4 is an explanatory view illustrating an example of an NW-side IF in an IF blade;

FIG. 5 is an explanatory view illustrating an exemplary format configuration of a DHCP frame;

FIGS. 6A and 6B are an operation sequence diagram illustrating exemplary process operations of a failed blade, a replacement destination blade, and a monitoring server in relation to a replacement process;

FIGS. 7A and 7B are a flowchart illustrating an exemplary process operation of the monitoring server in relation to the replacement process; and

FIG. 8 is a state shift view illustrating an exemplary state shift in relation to the replacement process.

### DESCRIPTION OF EMBODIMENTS

In the server monitoring the rack mount type transmission apparatus, for example, when the IF blade of the replacement source is replaced with the IF blade of the replacement destination, a local IP address is assigned to the IF blade of the replacement destination through a manual operation, and the server specifies the IF blade of the replacement destination. Further, by specifying the IF blade of the replacement destination, the server may transfer the global IP address of the IF blade of the replacement source to the IF blade of the replacement destination.

However, it is necessary that the local IP address (internal address information) is assigned to the IF blade of the replacement destination through a manual operation. Thus, the global IP address (external address information) of the IF blade of the replacement source may not be transferred to the IF blade of the replacement destination.

Hereinafter, embodiments of a technology in which the external address information of the IF blade of the replacement source may be automatically transferred to the IF blade of the replacement destination will be described in detail. The present disclosure is not limited to the embodiments. The embodiments described below may be appropriately combined with each other within a range that does not cause inconsistency.

### Embodiments

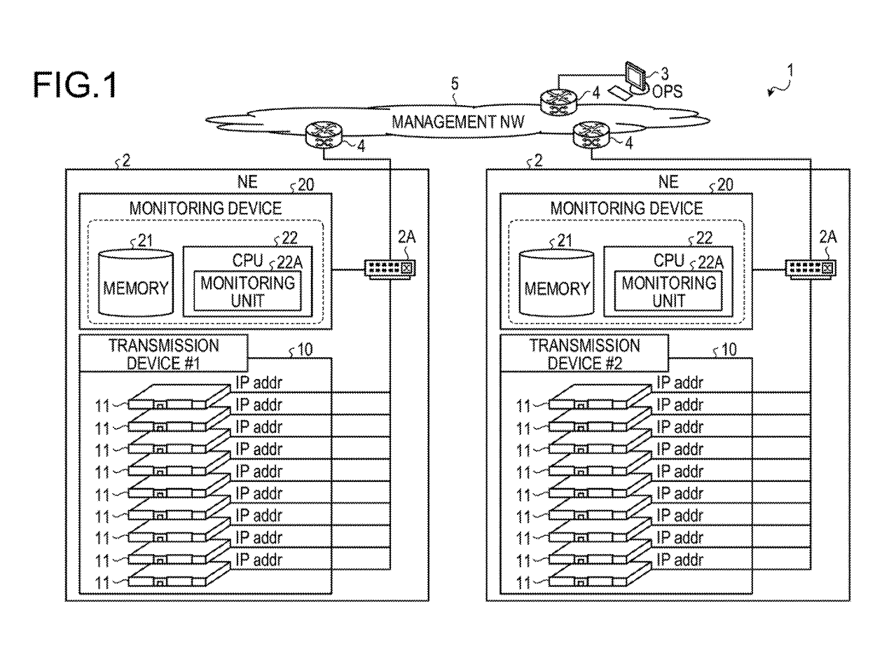

FIG. 1 is an explanatory view illustrating an example of a transmission system 1 according to an embodiment. The transmission system 1 illustrated in FIG. 1 includes a plurality of network elements (NEs) 2, an operator system (OPS) 3, relay apparatus 4, and a management network (NW) 5.

A local area network (LAN) is formed with an NE 2, and the NE 2 includes a relay device 2A, a transmission apparatus 10 capable of mounting with a plurality of interface (IF) blades 11, and a monitoring device 20. The relay device 2A relays a communication between the relay apparatus 4 on the side of the management NW 5 and the transmission apparatus 10, between the relay apparatus 4 and the monitoring device 20, and between the transmission apparatus 10 and the monitoring device 20 through a control communication. The control communication is, for example, a control communication of a data communication channel (DCC) or a general communication channel (GCC).

The transmission apparatus 10 is an IF blade group that is mounted with the plurality of IF blades 11 connected to communicate with a main signal network (not illustrated). The IF blades 11 are communication cards for the communication connection with the main signal network. The monitoring device 20 monitors the operating state of each of the IF blades 11 in the transmission apparatus 10, and furthermore, manages attribute information of each of the IF blades 11.

The monitoring device 20 is connected to communicate with each of the IF blades 11 in the transmission apparatus 10 through the control communication. In addition, an IP address is allocated to each of the monitoring device 20 and the IF blades 11. The monitoring device 20 specifies each of the IF blades 11 that are being mounted in the transmission apparatus 10, with the IP address.

The monitoring device 20 includes a memory 21 and a central processing unit (CPU) 22. The memory 21 is an area that stores various types of information related to the monitoring device 20. The CPU 22 controls the entire monitoring device 20. The CPU 22 executes a processing function as a monitoring unit 22A, by executing the various programs stored in the memory 21. The monitoring unit 22A has a function to monitor the upper layer or the physical layer of the transmission apparatus 10.

The OPS 3 is, for example, a maintenance terminal through which an operation center side manages the entire transmission system 1. Instead of the OPS 3, a soft defined network (SDN) controller may be used. The relay apparatus 4 is, for example, communication apparatus that relays between the OPS 3 and the management NW 5 or between the NE 2 and the management NW 5. The OPS 3 has an access path to each of the NEs 2, to access each of the IF blades 11 within the transmission apparatus 10 by using the IP address via the relay apparatus 4, and monitor the operating state of each of the IF blades 11.

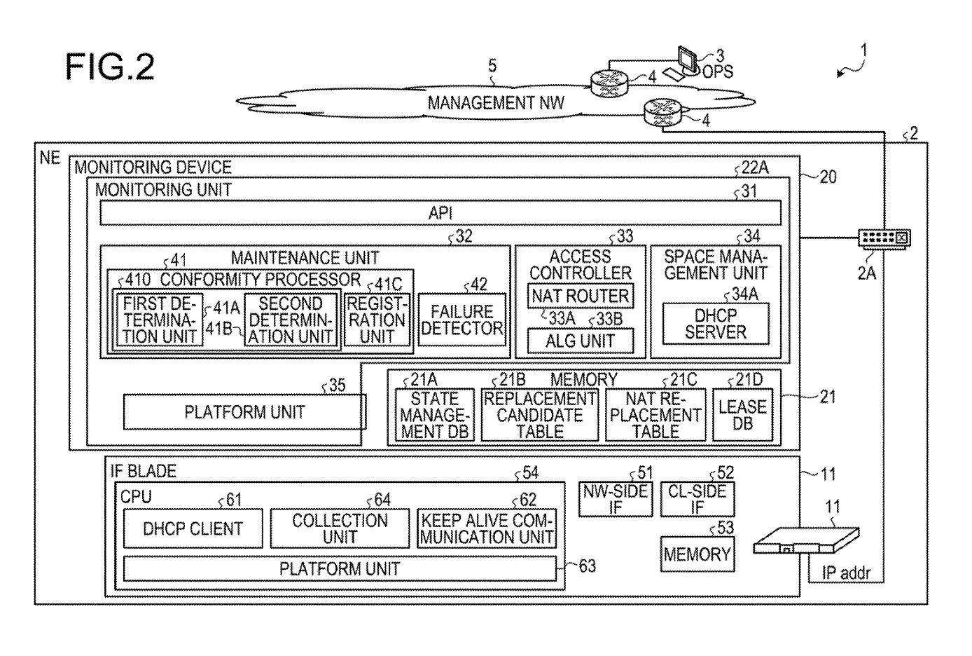

FIG. 2 is an explanatory view illustrating an exemplary interior of the NE 2. The memory 21 in the monitoring device 20 includes a state management DB 21A, a replacement candidate table 21B, a network address translation (NAT) table 21C, and a lease DB 21D.

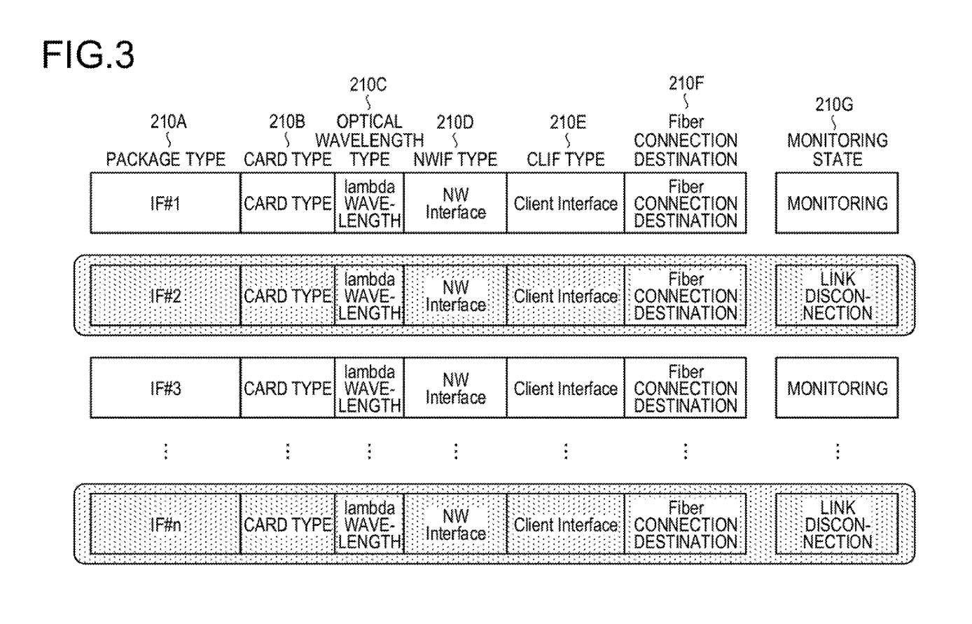

The state management DB 21A manages the operating state of each of the IF blades 11 that are being mounted in the transmission apparatus 10. FIG. 3 is an explanatory view illustrating an exemplary DB configuration of the state management DB 21A. The state management DB 21A illustrated in FIG. 3 manages state information including an attribute and an operating state of each of the IF blades 11. The state information is managed by associating a package type 210A, a card type 210B, an optical wavelength type 210C, an NWIF type 210D, a CLIF type 210E, a fiber connection destination 210F, and a monitoring state 210G with each other. The package type 210A is an ID for identifying each of the IF blades 11. The card type 210B is information indicating an attribute type of each of the IF blades 11. The optical wavelength type 210C is an optical wavelength used in each of the IF blades 11. The NWIF type 210D is information indicating a type of an NW-side IF connected with the main signal network, for example, an effective baud rate. The CLIF type 210E is information indicating a type of a CL-side IF, for example, an effective baud rate. The fiber connection destination 210F is, for example, information indicating a connection destination node of an optical fiber connected with the main signal network. The monitoring state 210G is information indicating a state as to whether an IF blade is an IF blade which is being monitored by the monitoring device 20. The monitoring state 210G is, for example, a state of being monitored or link disconnection (failure).

The replacement candidate table 21B manages state information of a failed IF blade 11 to be described later. The NAT table 21C manages a local IP address and a global IP address of each of the IF blades 11 and the monitoring device 20 in the NE 2 in association with each other. In addition, the local IP address is an IP address that is used between the transmission apparatus 10 and the monitoring device 20 in the NE 2 to specify each of the monitoring device 20 and the IF blades 11 in the NE 2. The global IP address is an IP address that is used between the exterior of the NE 2, for example, the OPS 3 and the NE 2 to specify the NE 2. The lease DB 21D manages a local IP address that may be allocated or has already been allocated in the NE 2. The lease DB 21D manages the allocated local IP address in association with a MAC address of each of the IF blades 11 in the NE 2.

The monitoring unit 22A in the CPU 22 includes an application programming interface (API) 31, a maintenance unit 32, an access controller 33, a space management unit 34, and a platform unit 35. The API 31 is a communication IF that is in charge of a communication with the OPS 3. The maintenance unit 32 monitors each of the IF blades 11 in the transmission apparatus 10. The maintenance unit 32 includes a conformity processor 41 and a failure detector 42.

The failure detector 42 detects a failure of the IF blades 11 in the transmission apparatus 10. The failure detector 42 monitors keep alive signals from the IF blades 11, and when detecting a link disconnection between IF blades 11, the failure detector 42 detects a failure of a corresponding IF blade 11. When detecting the failure of the IF blade 11, the failure detector 42 determines that the IF blade 11 is a failed blade 11A, and registers state information of the failed blade 11A in the state management DB 21A. Further, the failure detector 42 extracts the state information of the failed blade 11A from the state management DB 21A, and registers the extracted state information of the failed blade 11A in the replacement candidate table 21B.

The conformity processor 41 determines a conformity at the time of replacing an IF blade 11 in the transmission apparatus 10, that is, a conformity which enables the replacement between the IF blade 11 of the replacement source and the IF blade 11 of the replacement destination. In addition, the IF blade 11 of the replacement source is an IF blade 11 to be replaced such as, for example, the failed blade 11A. The IF blade 11 of the replacement destination is a spare IF blade 11 which replaces the IF blade 11 to be replaced, for example, the replacement destination blade 11B.

The conformity processor 41 includes a determination unit 410 and a registration unit 41C. The determination unit 410 is, for example, a processor that determines conformity evaluation indicating whether the replacement destination blade 11B is an IF blade 11 that may replace the failed blade 11A. The determination unit 410 includes a first determination unit 41A and a second determination unit 41B. The first determination unit 41A starts a first conformity evaluation determination to determine whether, when attribute information (card type) of an IF blade 11 is detected from a DHCP (Discover) frame to be described later, the IF blade 11 is mounted as a replaceable IF blade 11. When the attribute information (card type) of the replacement destination blade 11B is detected, the first determination unit 41A designates the attribute information (card type) of the failed blade 11A that has been registered in the replacement candidate table 21B. The first determination unit 41A compares the attribute information of the designated failed blade 11A and the attribute information of the replacement destination blade 11B with each other. When the attribute information of the registered and designated failed blade 11A and the attribute information of the replacement destination blade 11B conform to each other, the first determination unit 41A determines that the first conformity evaluation between the replacement destination blade 11B and the failed blade 11A is OK. When the attribute information of the designated failed blade 11A and the attribute information of the replacement destination blade 11B do not conform to each other, the first determination unit 41A determines that the first conformity evaluation between the replacement destination blade 11B and the failed blade 11A is NG. In addition, when attribute information of an undesignated failed blade 11A exists in the replacement candidate table 21B, the first determination unit 41A sequentially designates the attribute information of the undesignated failed blade 11A. Then, the first determination unit 41A restarts the first conformity evaluation to sequentially compare the attribute information of the failed blade 11A and the attribute information of the replacement destination blade 11B with each other.

When the first determination unit 41A determines that the first conformity evaluation between the failed blade 11A and the replacement destination blade 11B is OK, the second determination unit 41B requests a measurement result to be used for a second conformity evaluation from the replacement destination blade 11B, based on the attribute information of the failed blade 11B. First, the second determination unit 41B notifies the replacement destination blade 11B of measurement data to be used for the measurement result of the second conformity evaluation. In addition, the measurement data is the failed blade 11A, and for example, an optical wavelength that was used prior to the failure. Based on the measurement data, the replacement destination blade 11B outputs a measurement result indicating whether reception light could have been received by local emitted light of the optical wavelength used in the failed blade 11A. When detecting the measurement result from the replacement destination blade 11B, the second determination unit 41B determines the second conformity evaluation between the failed blade 11A and the replacement destination blade 11B based on the measurement result.

When the measurement result indicates that the reception light could have been received, the second determination unit 41B determines that the second conformity evaluation of the replacement destination blade 11B is OK. When it is determined that the second conformity evaluation of the replacement destination blade 11B is OK, the second determination unit 41B deletes the attribute information of the failed blade 11A, which is related to the second conformity evaluation, from the replacement candidate table 21B. Further, when the measurement result indicates that the reception light could not have been received, the second determination unit 41B determines that the second conformity evaluation is NG. When the second determination unit 41B determines that the second conformity evaluation is NG, the first determination unit 41A determines whether there is attribute information of an undesignated failed blade 11A in the replacement candidate table 21B. When it is determined that there is attribute information of an undesignated failed blade 11A, the first determination unit 41A sequentially designates the attribute information of the undesignated failed blade 11A and restarts the first conformity evaluation.

When it is determined that the second conformity evaluation is OK, the registration unit 41C updates and registers the global IP address associated with the local IP address of the failed blade 11A in the NAT table 21C, in association with the local IP address of the replacement destination blade 11B. By updating and registering the global IP address of the failed blade 11A in the NAT table 21C in association with the local IP address of the replacement destination blade 11B, the registration unit 41C may replace the failed blade 11A with the replacement destination blade 11B by validating the CL-side IF 52 so as to recover the failure. Then, the monitoring device 20 notifies the OPS 3 of the failure recovery.

The access controller 33 is an address converter that exchanges a global IP address and a local IP address to enable the communication connection between the OPS 3 and each of the IF blades 11. The access controller 33 includes an NAT router 33A and an application layer gateway (ALG) unit 33B. The NAT router 33A converts a global IP address and a local IP address by referring to the NAT table 21C. When the registration unit 41C completes the transfer of the global IP address of the failed blade 11A to the replacement destination blade 11B, the access controller 33 notifies the OPS 3 of the failure recovery. As a result, the OPS 3 may access the replacement destination blade 11B.

The space management unit 34 assigns a local IP address to each of the IF blades 11 that are being mounted in the transmission apparatus 10. The space management unit 34 includes a DHCP server 34A. The DHCP server 34A communicates information with each of the IF blades 11 by using DHCP protocol. For example, when mounting of a new IF blade 11 is detected in the IF blade group 11, the DHCP server 34A assigns an allocable IP address to the new IF blade 11 by referring to the lease DB 21D, and updates the lease DB 21D to incorporate the allocated IP address. The platform unit 35 is, for example, a communication IF with each of the IF blades 11 in the transmission apparatus 10.

Each IF blade 11 in the transmission apparatus 10 includes an NW-side IF 51, a CL-side IF 52, a memory 53, and a CPU 54. The NW-side IF 51 is a communication IF that is in charge of the communication with the main signal network. The CL-side IF 52 is a communication IF that is in charge of a communication with a client. The memory 53 is an area that stores various types of information related to the IF blades 11. The CPU 54 controls all IF blades 11. By executing various programs, the CPU 54 executes a DHCP client 61, a keep alive communication unit 62, a platform unit 63, and a collection unit 64 as functions. The DHCP client 61 communicates with the DHCP server 34A in the monitoring device 20 by using a DHCP frame. For example, the DHCP client 61 acquires an IP address from the DHCP server 34A. The keep alive communication unit 62 communicates a keep alive signal with the monitoring device 20, and monitors a link disconnection with the monitoring device 20. The platform unit 63 is, for example, a communication IF with the monitoring device 20. The collection unit 64 sets determination data used for the second conformity evaluation in the NW-side IF 51, collects the measurement result from the NW-side IF 51, and notifies the monitoring device 20 of the measurement result through the DHCP client 61.

In addition, the failure detector 42 in the monitoring device 20 detects a failure of the side of the IF blades 11 by reception of a failure (FLT) of a DHCP (INFORM) frame from the IF blades 11, in addition to presence/absence of the reception of the keep alive signals from the IF blades 11.

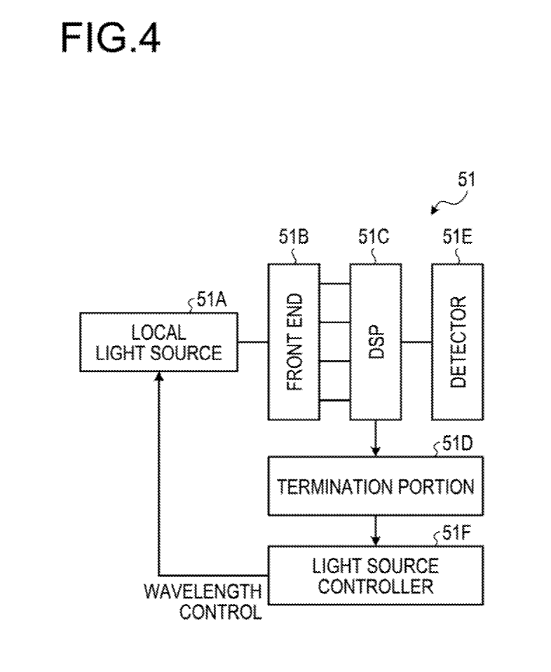

FIG. 4 is an explanatory view illustrating an example of the NW-side IF 51 in an IF blade 11. The NW-side IF 51 includes a local light source 51A, a front end 51B, a DSP 51C, a termination portion 51D, a detector 51E, and a light source controller 51F. The local light source 51A is a laser diode (LD) that emits local light of an arbitrary wavelength. The front end 51B converts the optical signal of the I and Q component of X polarization and Y polarization which is obtained by being mixed with a received optical signal, into an electric signal without delaying the phase of the logical emitted light. The DSP 51C executes a digital signal processing on the electric signal. The termination unit 51D executes a termination processing of, for example, an optical transport network over header (OTNOH) from the electric signal that has been subjected to the digital signal processing. The detector 51E detects an error from the electric signal that has been subjected to the digital signal processing. The light source controller 51F drives and controls the local light emission source 51A in order to change the optical wavelength of the local emitted light of the local light source 51A. The light source controller 51F sets the optical wavelength to the wavelength of the local emitted light used in the failed blade 11A based on the determination data used for the second conformity evaluation determination, and acquires a measurement result as to whether the phases of the received signal light and the local emitted light conform to each other, that is, whether the signal light is normally received.

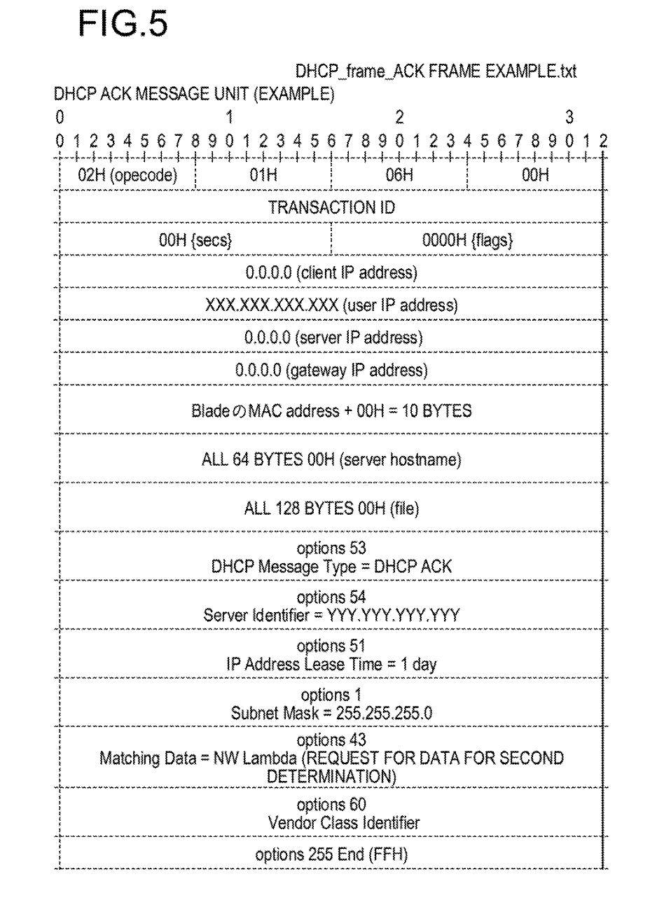

FIG. 5 is an explanatory view illustrating an exemplary format configuration of the DHCP frame. The DHCP frame includes an operation code, a transaction ID, a client-side IP address, a user-side IP address, and a server-side IP address. Further, the DHCP frame includes a GW-side IP address, a MAC address on the side of the IF blades, a server-side host name, a file, and an option area. The option area is an area in which arbitrary information may be optically mounted.

In the option area, a DHCP message type is placed in an option “53,” a server identifier is placed in an option “54,” an IP address lease time is placed in an option “51,” and a subnet mask is placed in an option “1.” Further, the determination data used for the second conformity evaluation is placed in an option “43.” The DHCP server 34A in the monitoring device 20 places the determination data used for the second conformity evaluation in the option “43” within the DHCP frame, and notifies the IF blades 11 of the DHCP frame. Further, a vender class identifier is placed in an option “60.”

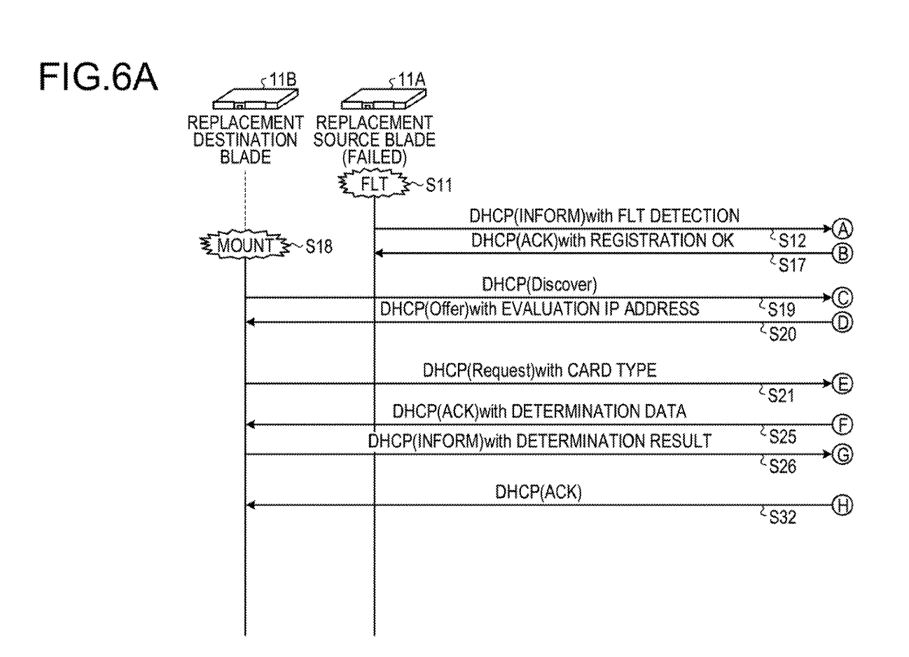

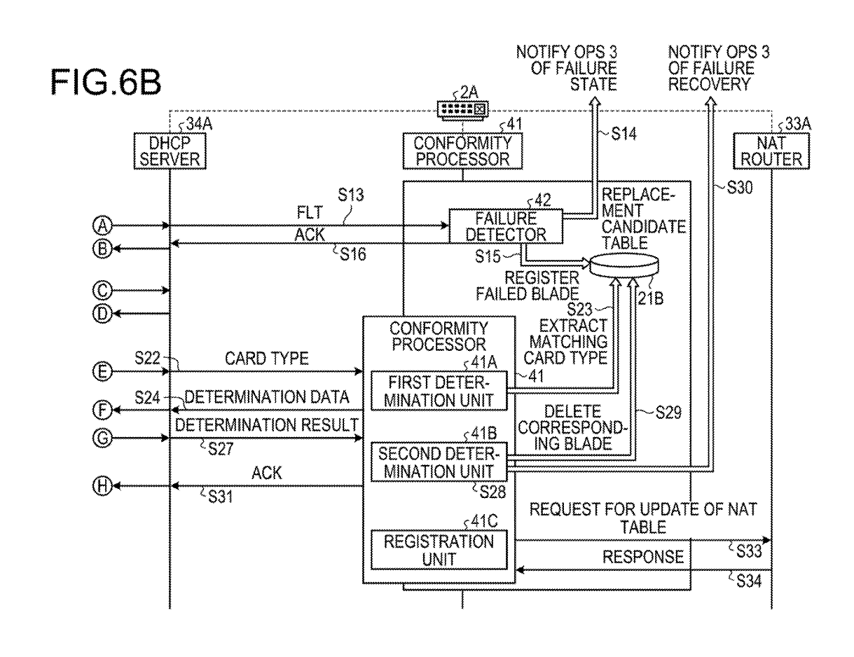

Next, the operation of the transmission system 1 of the present embodiment will be described. FIGS. 6A and 6B are an operation sequence diagram illustrating exemplary processing operations of the failed blade 11A, the replacement destination blade 11B, and the monitoring device 20 in relation to the maintenance and replacement processing. In addition, the failed blade 11A is a failed IF blade 11 among the IF blades 11 in the transmission apparatus 10. The replacement destination blade 11B is, for example, an IF blade 11 newly mounted in the transmission apparatus 10.

When a failure is detected (operation S11), the DHCP client 61 in the failed blade 11A transmits a DHCP (INFORM) frame for the FLT (failure) detection to the DHCP server 34A in the monitoring device 20 (operation S12). Upon receiving the DHCP (INFORM) frame for the FLT detection, the DHCP server 34A notifies the failure detector 42 of the FLT (operation S13).

Upon detecting the FLT, the failure detector 42 notifies the OPS 3 of the failure state of the failed blade 11A (operation S14). Then, the failure detector 42 registers the attribute information of the failed blade 11A in the replacement candidate table 21B (operation S15). Then, the failure detector 42 sends an ACK notification for the FLT notification from the DHCP server 34A, to the DHCP server 34A (operation S16).

Upon receiving the ACK notification from the failure detector 42, the DHCP server 34A transmits a DHCP (ACK) frame of registration OK to the failed blade 11A (operation S17). When the replacement destination blade 11B is newly mounted in the transmission apparatus 10 (operation S18), the replacement destination blade 11B transmits a DHCP (Discover) frame of the replacement destination blade 11B to the DHCP server 34A (operation S19). In addition, the terms “newly mounted” indicate a state where the replacement destination blade 11B is mounted in the transmission apparatus 10, and a power is supplied to the replacement destination blade 11B. Upon receiving the DHCP (Discover) frame, the DHCP server 34A transmits a DHCP (Offer) frame including the evaluation IP address to the replacement destination blade 11B (operation S20). In addition, the evaluation IP address is a local IP address that is assigned to the replacement destination blade 11B.

The replacement destination blade 11B transmits a DHCP (Request) frame including the card type of the replacement destination blade 11B to the DHCP server 34A (operation S21). Upon receiving the DHCP (Request) frame, the DHCP server 34A notifies the first determination unit 41A of the card type of the replacement destination blade 11B (operation S22).

The first determination unit 41A determines whether the failed blade 11A matching the card type of the replacement destination blade 11B is present in the replacement candidate table 21B. When it is determined that the failed blade 11A matching the card type of the replacement destination blade 11B is present in the replacement candidate table 21B (operation S23), the first determination unit 41A transmits the determination data to the DHCP server 34A (operation S24). Further, the first determination unit 41 acquires the optical wavelength used prior to the failure of the failed blade 11A as the determination data, by referring to the attribute information (optical wavelength type) of the failed blade 11A.

Depending on the determination data, the DHCP server 34A transmits a DHCP (ACK) frame including the determination data to the replacement destination blade 11B in response to the DHCP (Request) frame (operation S25). The NW-side IF 51 in the replacement destination blade 11B executes the measurement processing to be used for the second conformity evaluation based on the determination data in the DHCP (ACK) frame, and collects the measurement result. The replacement destination blade 11B transmits a DHCP (INFORM) frame including the collected measurement result to the DHCP server 34A (operation S26). The DHCP server 34A notifies the second determination unit 41B of the measurement result (operation S27). The second determination unit 41B determines the second conformity evaluation of the replacement destination blade 11B based on the measurement result. Then, when the second conformity evaluation of the replacement destination blade 11B is OK (operation S28), the second determination unit 41B deletes the attribute information of the failed blade 11A to be replaced with the replacement destination blade 11B from the replacement candidate table 21B (operation S29). Further, the second determination unit 41B notifies the OPS 3 of the failure recovery (operation S30).

The second determination unit 41B notifies the DHCP server 34A of the ACK of the OK of the second conformity evaluation (operation S31). Upon detecting the ACK from the second determination unit 41B, the DHCP server 34A transmits a DHCP (ACK) frame for the DHCP (INFORM) frame to the replacement destination blade 11B (operation S32). In addition, the registration unit 41C notifies the NAT router 33A of a request for update of the NAT table 21C to assign the global IP address of the failed blade 11A to the local IP address of the replacement destination blade 11B (operation S33). In response to the update request, the NAT router 33A updates the NAT table 21C to allocate the global IP address of the failed blade 11A to the local IP address of the replacement destination blade 11B. Then, when the update of the NAT table 21C is completed, the NAT router 33A notifies the registration unit 41C of a response indicating the completion of the allocation (operation S34).

Upon detecting the DHCP (INFORM) frame of the FLT from an IF blade 11, the monitoring device 20 determines that the IF blade is the failed blade 11A, and registers the state information of the failed blade 11A in the replacement candidate table 21B. As a result, the monitoring device 20 may recognize the failed blade 11A.

Upon detecting the DCP (Discover) frame from the newly mounted IF blade 11, the monitoring device 20 acquires the card type from the newly mounted IF blade 11. Further, the monitoring device 20 refers to the replacement candidate table 21B, and when the failed blade 11A matching the card type of the newly mounted IF blade 11 is present, the monitoring device 20 determines that the first conformity evaluation of the newly mounted IF blade 11 is OK.

In addition, after determining that the first conformity evaluation of the newly mounted IF blade 11 is OK, the monitoring device 20 requests the measurement result to be used for the second conformity evaluation from the newly mounted IF blade 11. Further, when the second conformity evaluation is OK based on the measurement result from the newly mounted IF blade 11, the monitoring device 20 determines that the newly mounted IF blade 11 is the replacement destination blade 11B of the failed blade 11A. Further, the monitoring device 20 allocates the global IP address allocated to the local IP address of the failed blade 11A in association with the local IP address of the replacement destination blade 11B. As a result, the monitoring device 20 may automatically transfer the global IP address of the failed blade 11A to the replacement destination blade 11B so as to implement the failure recovery.

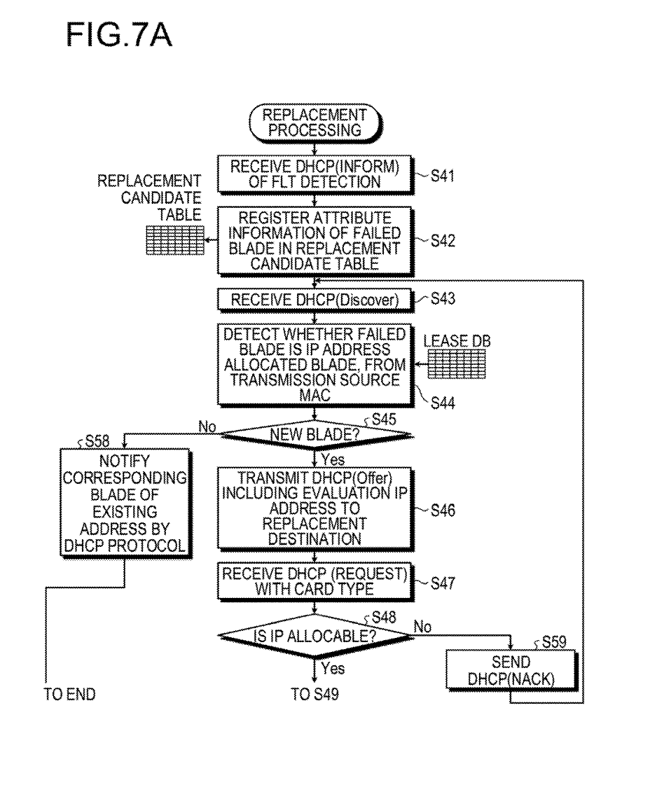

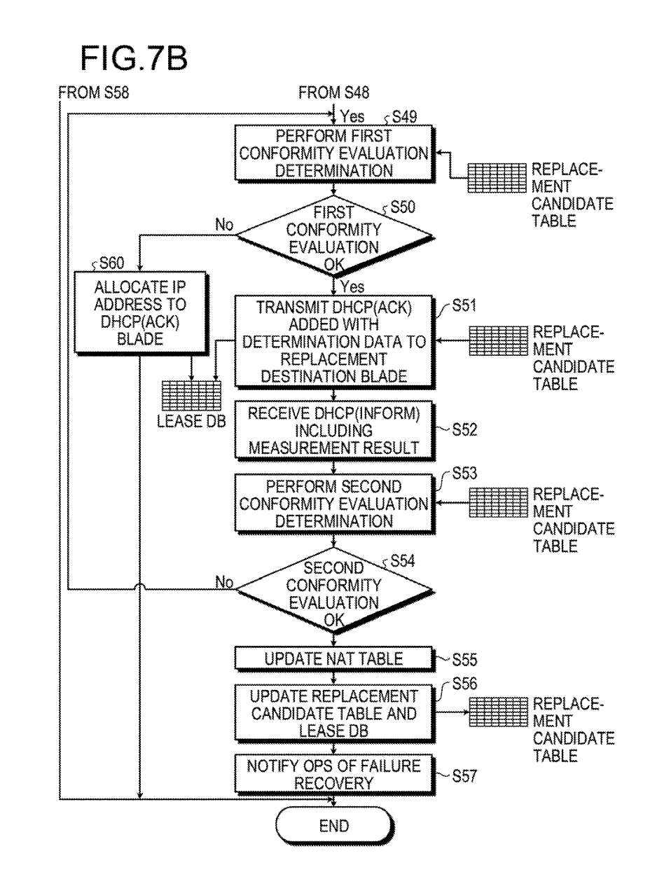

FIGS. 7A and 7B are a flowchart illustrating an exemplary processing operation of the monitoring device 20 in relation to the replacement processing. In FIGS. 7A and 7B, upon receiving the DHCP (INFORM) frame of the FLT detection from the failed blade 11A (operation S41), the monitoring device 20 updates and registers the state information corresponding to the failed blade 11A as “being failed” in the state management DB 21A. Further, the monitoring device 20 registers the attribute information of the failed blade 11A in the replacement candidate table 21B (operation S42).

Upon receiving the DHCP (Discover) frame (operation S43), the monitoring device 20 searches the IF blade 11 from the transmission source MAC address of the DHCP (Discover) frame, by referring to the allocated IP address in the lease DB 21D (operation S44). When the transmission source MAC address is absent in the lease DB 21D as a result of the search, the monitoring device 20 determines that the IF blade 11 is a new IF blade 11.

Based on the search result, the monitoring device 20 determines whether the IF blade 11 that has transmitted the DHCP (Discover) frame is a new IF blade 11 (operation S45). When it is determined that the IF blade 11 is a new IF blade 11 (“Yes” in operation S45), the monitoring device 20 transmits the DHCP (Offer) frame including the evaluation IP address to the new IF blade 11 (operation S46). The evaluation IP address is the local IP address assigned to the new IF blade 11.

The monitoring device 20 receives a DHC (Request) frame including a request for acquiring the evaluation IP address and the card type of the new IF blade 11 (operation S47). Upon receiving the DHCP (Request) frame, the monitoring device 20 determines whether the evaluation IP address may be allocated to the IF blade 11 that has transmitted the DHCP (Request) frame (operation S48). In addition, in the processing of operation S48, the evaluation IP address may be allocated to another IF blade 11 in a time lag between the transmission of the DHCP (Offer) frame including the evaluation IP address and the reception of the DHCP (Request) including the card type. Thus, the processing of operation S48 is performed to cope with this circumstance.

When it is determined that the IP address may be allocated (“Yes” in operation S48), the monitoring device 20 executes the first conformity evaluation determination (operation S49). The monitoring device 20 determines whether the result of the first conformity evaluation determination is OK (operation S50). When it is determined that the first conformity evaluation is OK (“Yes” in operation S50), the monitoring device 20 transmits the DHCP (ACK) frame including the evaluation IP address and the determination data to the new IF blade 11 (operation S51). In addition, the evaluation IP address is the local IP address assigned to the new IF blade 11 by the DHCP server 34A in the monitoring device 20, and is registered in the lease DB 21D. The determination data is, for example, wavelength information of the local emitted light that was used prior to the failure of the failed blade 11A. Based on the determination data in the DHCP (ACK) frame, the NW-side IF 51 in the new IF blade 11 sets the wavelength information of the local emitted light in the local light source 51A, executes the measurement processing, transmits the DHCP (INFORM) frame including the measurement result to the monitoring device 20.

When receiving the DHCP (INFORM) frame including the measurement result from the new IF blade 11 (operation S52), the monitoring device 20 executes the second conformity evaluation determination (operation S53). The monitoring device 20 determines whether the result of the second conformity evaluation determination is OK (operation S54). When it is determined that the second conformity evaluation is OK (“Yes” in operation S54), the monitoring device 20 updates the NAT table 21C (operation S55). That is, the monitoring device 20 deletes the local IP address of the failed blade 11A and registers the global IP address of the failed blade 11A in association with the local IP address of the replacement destination blade 11B. As a result, the global IP address of the failed blade 11A is transferred to the replacement destination blade 11B. Further, the monitoring device 20 updates the replacement candidate table 21B and the lease DB 21D (operation S 56). The monitoring device 20 deletes the state information of the failed blade 11A from the replacement candidate table 21B, and deletes the local IP address corresponding to the MAC address of the failed blade 11A from the lease DB 21D. Then, the monitoring device 20 notifies the OPS 3 of the failure recovery (operation S57), and ends the processing operation illustrated in FIG. 7. When it is determined that the IF blade 11 is not the new IF blade 11 (“No” in operation S45), the monitoring device 20 notifies the IF blade 11 of the IP address allocated by the DHCP protocol (operation S58), and ends the processing operation illustrated in FIGS. 7A and 7B.

When it is determined that the IP address may not be allocated (“No” in operation S48), the monitoring device 20 transmits DHCP (NACK) to the IF blade 11A of the replacement destination (operation S59), and proceeds to operation S43 to receive and monitor the DHCP (Discover) frame. When it is determined that the result of the first conformity evaluation determination is not OK (“No” in operation S50), the monitoring device 20 transmits the DHCP (ACK) frame to the IF blade 11 (operation S60), and ends the processing operation illustrated in FIGS. 7A and 7B. When it is determined that the result of the second conformity evaluation determination is not OK (“No” in operation S54), the monitoring device 20 proceeds to operation S49 to restart the first conformity evaluation determination.

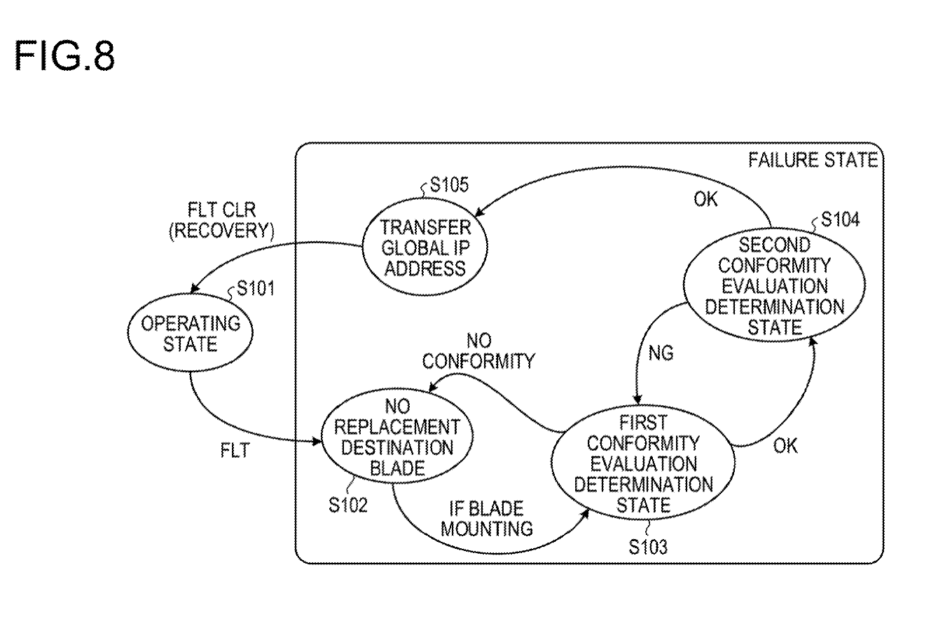

FIG. 8 is a state shift diagram illustrating an exemplary state shift in relation to the replacement processing. In FIG. 8, the state of the replacement processing may be classified into an operating state (operation S101) and a failed state. The failed state may be classified into a replacement destination blade absence state (operation S102), a first conformity evaluation determination state (operation S103), a second conformity evaluation determination state (operation S104), and a state of transferring the global IP address to the replacement destination blade (operation S105).

In the operating state of the operation S101, when a FLT of the IF blade 11 is detected, the state shifts to the replacement destination blade absence state of operation S102. In the replacement destination blade absence state of the operation S102, when mounting of a new IF blade 11 is detected, the state shifts to the first conformity evaluation determination state of operation S103.

In the first conformity evaluation determination state of operation S103, when it is determined that the result of the first conformity evaluation determination is OK, the state shifts to the second conformity evaluation determination state of operation S104. In the second conformity evaluation determination state of operation S104, when it is determined that the result of the second conformity evaluation determination is OK, the global IP address of the failed blade 11A is transferred to the replacement destination blade 11B, and the state shifts to the global IP address transfer state of operation S105. In the global IP address transfer state of operation S105, when the failure recovery is detected by the completion of the transfer from the failed blade 11A to the replacement destination blade 11B, the state shifts to the operating state of operation S101.

In the first conformity evaluation determination state of operation S103, when all results of the first conformity evaluation determination are NG, the state shifts to the replacement blade absence state of operation S102. In the second conformity evaluation determination state of operation S104, when it is determined that the result of the second conformity evaluation determination is NG, the state shifts to the first conformity evaluation determination state of operation S103.

When detecting the failed blade 11A, the monitoring device 20 of the present embodiment registers the attribute information of the failed blade 11A in the replacement candidate table 21B. When detecting attribute information of a newly mounted IF blade 11, the monitoring device 20 determines the first conformity evaluation indicating whether the attribute information of the failed blade 11A matching the attribute information of the newly installed IF blade 11 is present in the replacement candidate table 21B. When it is determined that the first conformity evaluation is OK, the monitoring device 20 acquires the measurement result to be used for the second conformity evaluation from the newly mounted IF blade 11, and determines the second conformity evaluation indicating whether the measurement result meets the conformity condition. When it is determined that the second conformity evaluation is OK, the monitoring device 20 updates the global IP address of the failed blade 11A as the global IP address of the replacement destination blade 11B. As a result, the global IP address of the failed blade 11A is transferred to the replacement destination blade 11B, and automation of the failure recovery may be implemented without requiring a manual operation.

When it is determined that the second conformity evaluation is NG, the monitoring device 20 determines the first conformity evaluation indicating whether another failed blade 11A matching the attribute information of the newly mounted IF blade 11 is present in the replacement candidate table 21B. As a result, the first conformity evaluation is restarted even when the second conformity evaluation is NG, the automation of the failure recovery may be implemented.

In addition, the optical wavelength used prior to the failure of the failed blade 11A has been described as an example of the measurement data to be used for the determination processing of the second conformity evaluation. However, the present disclosure is not limited thereto, and an appropriate modification may be made. As the measurement data, for example, a wavelength dispersion characteristic of received light prior to the failure, a reception power level, a reception training signal or header information of a received frame (OTN or Ether frame) may be used. The second determination unit 41B executes the determination processing of the second conformity evaluation indicating whether the measurement result for the measurement data meets the reception condition prior to the failure, for the IF blade 11 to be determined. The second determination unit 41B receives the measurement result for the measurement data from the IF blade 11 to be determined, and when the measurement result prior to the failure may be obtained from the measurement result, the second determination unit 41B determines that the second conformity evaluation of the IF blade 11 to be determined is OK.

In the above-described embodiment, when it is determined that the first conformity evaluation is OK, the monitoring device 20 determines the second conformity evaluation, and when it is determined that the second conformity evaluation is OK, the monitoring device 20 transfers the global IP address of the failed blade 11A to the replacement destination blade 11B. However, when it is determined that the first conformity evaluation is OK, the monitoring device 20 may transfer the global IP address of the failed blade 11A to the replacement destination blade 11B without determining the second conformity evaluation.

In the embodiment, in the determination processing of the first conformity evaluation, the DHCP (Discover) frame is sent depending on mounting of an IF blade 11 from the mounted IF blade 11 to the transmission apparatus 10. However, when a specific IF blade 11 of the IF blades 11 being mounted in the transmission apparatus 10 is instructed as the replacement destination of the failed blade 11A, the DHCP (Discover) frame may also be sent from the instructed IF blade 11.

In addition, each component of the respective illustrated units is not necessarily required to be configured physically as illustrated. That is, specific forms of distribution or integration of the individual units are not limited to those illustrated, and all or some of the units may be configured to be functionally or physically distributed or integrated in arbitrary units depending on, for example, various loads or use conditions.

In addition, all or some of the various process functions performed in the respective devices may be implemented on a central processing unit (CPU) (or a microcomputer such as an MPU or a micro controller unit (MCU)). In addition, some or all of the various process functions may be implemented on a program analyzed and executed in a CPU (or a microcomputer such as a MPU or a MCU) or on hardware by a wired logic.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. A monitoring device configured to couple to a transmission apparatus having a plurality of interface cards, and control a replacement of the plurality of interface cards, the monitoring device comprising:
a memory in which state information including attribute information and an operating state of each of the plurality of interface cards are stored;
a processor coupled to the memory and the processor configured to:
monitor the operating state of each of the plurality of interface cards associated with internal address information assigned to each of the plurality interface cards;
determine whether first attribute information of a first interface card of the plurality of interface cards of a replacement source matches second attribute information of a second interface card of the plurality of interface cards of a replacement destination; and
update external address information of the first interface card to external address information of the second interface card, when the first attribute information matches the second attribute information.

2. The monitoring device according to claim 1,
wherein the processor is configured to:
when the first attribute information matches the second attribute information,
set a communication condition of the first interface card to the second interface card;
acquire a measurement result of a conformity evaluation for the communication condition from the second interface card;
determine whether the measurement result meets a conformity condition; and
update the external address information of the first interface card to the external address information of the second interface card, when the measurement result meets the conformity condition.

3. The monitoring device according to claim 2,
wherein the processor is configured to:,
when the measurement result does not meet the conformity condition,
determine whether attribute information of a communication card of the plurality of interface cards of another replacement source matches the second attribute information.

4. A card replacing method of a monitoring device configured to couple to a transmission apparatus having a plurality of interface cards, and control a replacement of the plurality of interface cards, the card replacing method comprising:
monitoring an operating state of each of the plurality of interface cards associated with internal address information assigned to each of the plurality interface cards;
determining whether first attribute information of a first interface card of the plurality of interface cards of a replacement source matches second attribute information of a second interface card of the plurality of interface cards of a replacement destination; and
updating external address information of the first interface card to external address information of the second interface card, when the first attribute information matches the second attribute information, by a processor.
